(19) United States
(12) Patent Application Publication
(10) Pub. No.: US 2011/0068062 A1
(43) Pub. Date: Mar. 24, 2011

(54) System for removing contaminants from a water circulation stream

(75) Inventor: John O. McClelland, Vinton, LA (US)

(73) Assignee: Culoco Energy, Inc.

(21) Appl. No.: 12/586,519

(22) Filed: Sep. 23, 2009

(51) Int. Cl. B01D 35/14; B01D 35/143; C02F 1/00

(52) U.S. Cl. 210/741; 210/137; 210/90

(57) ABSTRACT

Suspended solids are removed from a circulation line extending between an oil storage tank and a water reservoir. A filter is positioned between the storage tank and a circulation tank for collecting suspended solids carried by a circulated water stream from the storage tank. A pressure sensor and a transducer is mounted in a control unit positioned upstream from the pump and downstream of the filter to detect and out-of-range pressure condition and send a signal to the pump power supply for de-activating the pump. An alarm signal is generated alerting an operator of the low oil level in the storage tank or clogged filter.

### BACKGROUND OF THE INVENTION

This invention relates to a system for removing contaminants from hydrocarbon-containing liquids, and more particularly to a system of controlling operation of a circulation pump in such system.

Rigorous environmental regulations require multi-stage treatment of all hydrocarbon-containing liquids, including drilling waste, storage tank contents and the like. The industry employs primary treatment systems, such as heater treatment devices, gun barrels, separators, and the like. Oil pumped from a well usually contains significant quantities of salt water that is removed with the help of oil-water separators. Separated oil is transferred to an oil storage tank, while the water is collected in a separate vessel. However, modern oil-water separators still leave a small quantity of loosely emulsified water in the removed oil, as a consequence of which water and small solid particles tend to accumulate on the bottom of the oil storage tank.

Conventionally, a recirculation system is employed for removing the remaining water from the oil storage tank and for returning removed water to the oil-water separator. A pump is usually connected to the oil storage tank to provide the power necessary for moving the remaining water away from the oil storage tank and into the separator or water reservoir. The pumped water stream carries the suspended contaminants through the pump, which creates a significant problem, particularly if the level of oil in the storage tank is low.

The present invention contemplates provision of a system of water recirculation, which protects the circulation pump and removes contaminants from the system before they have an opportunity to damage the pump.

### SUMMARY OF THE INVENTION

It is, therefore, an object of the present invention to provide a system of removing contaminants from a water recirculation stream.

It is another object of the invention to provide a system of protecting a recirculation pump from damage by small particulate matter.

These and other objects of the invention are achieved through a provision of a system for removing contaminants from a water stream in a circulation line, where salted water is removed from an oil storage tank and delivered into a water reservoir. The storage tank is configured for retaining a pre-determined quantity of fluid containing unrefined oil, water and suspended solid contaminants. A water circulation conduit is connected to the storage tank for removing water using a powered circulation pump from the storage tank. A filter assembly is mounted between the storage tank and the circulation pump for collecting suspended solids from the water stream.

A control unit is mounted in the circulation conduit between the filter assembly and the circulation pump, said control unit being configured to detect an out-of-range pressure in the circulation conduit before the water stream reaches the circulation pump. The control unit has a pressure sensor and a transducer that is operationally connected to the power supply. Upon detection of low level of oil in the storage tank or a clogged filter, the transducer de-activates the pump and sends an alarm signal to an operator.

### BRIEF DESCRIPTION OF THE DRAWINGS

Reference will now be made to the drawings, wherein like parts are designated by like numerals, and wherein

FIG. 1 is a schematic view of the system of the present invention.

FIG. 2 is a detail exploded view of the filter device of the system of the present invention.

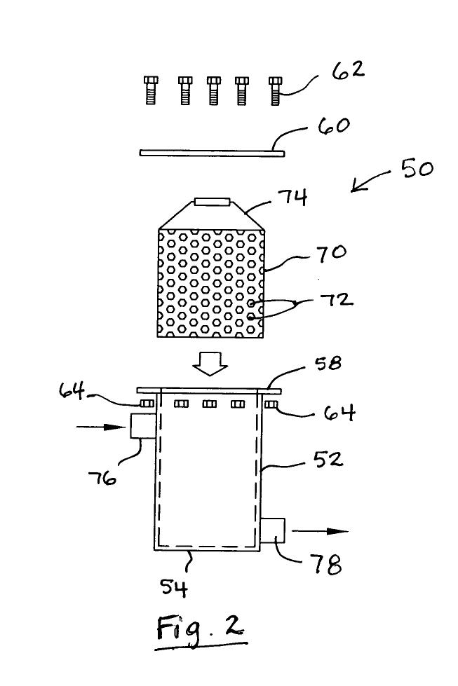

FIG. 3 schematically illustrates the step of cleaning of the filter basket of the filter assembly.

### DETAIL DESCRIPTION OF THE INVENTION

Turning now to the drawings in more detail, numeral 10 designates the system of removing contaminants according to the present invention. The system 10 comprises an oil storage tank 12, which receives a quantity of unrefined oil that may or may not have undergone a primary treatment, for instance in an oil-water separator vessel 14. In such separators, oil is separated from heavier material, in this instance water. The oil may also be deposited into the stock tank 12 from a field truck that sucks it up from a spill in the oil field by vacuum or from a pipeline that is run to the stock tank from a producing well.

In the oil-water separator vessel 14, oil 16, as a lighter liquid, rises, to the top of the separator vessel, while heavier emulsified water 18 settles, by gravity on the bottom. A water pump 20 connected to a lower portion of the separator vessel 14 transfers the salt water to a salt water reservoir 22. The recovered water is treated (flocculation, filtration, etc.) to local charge standards. This portion of the liquid phase of the oil stream is not re-circulated through the system of the instant invention.

Since the liquid oil leaves the oil-water separator 14 still retaining some of the water and solid particulate matter, heavy salt water and tiny particles tend to settle as a layer 30 in the lower portion of the oil storage tank 12, which may or may not receive the influx of fluid from the separator 14. A conduit 32 with a control valve 34 is connected to the oil storage tank 12 a distance above the bottom wall 36 of the tank 12. A sight glass 38 allows visual inspection of the level of oil in the storage tank 12. A transport truck (not shown) can be connected to the oil removal conduit 32 for removing oil from the storage tank 12 and delivering oil to another location.

A circulation pump 40 is fluidly connected to the oil storage tank 12 via a circulation conduit 42. An inlet of the conduit 42 is located adjacent the bottom wall 38, close to the area where the contaminant layer 30 is located.

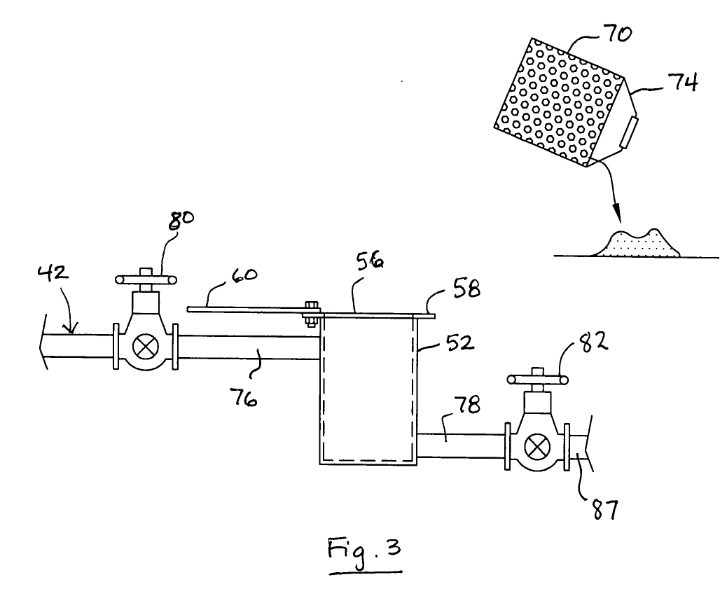

A filter assembly or scrubber 50 is mounted in fluid communication with the circulation line 42 between the circulation pump 40 and the oil storage tank 12. The filter assembly 50 comprises a hollow filter body 52, which can be a cylindrical vessel having a closed bottom 54 and an open top 56. A peripheral flange 58 is secured to the top 56, with the flange 58 having a greater diameter than the body 52. A lid or cover 60 fits over the flange 58 and is secured thereto by a plurality of bolts 62 fitted into through openings (not shown) formed in the flange 58. Threaded ends of the bolts 62 are secured on the underside of the flange 58 by nuts 64. The cover 60 can be moved in relation to the flange 58 by removing some of the bolts 62 and nuts 64, allowing the cover 60 to swing away from the open top 56, as shown in FIG. 3.

A mesh basket, or filter member 70 is configured for removable positioning in the body 52. The filter member 70 has a generally cylindrical body having a diameter at least slightly smaller than the inner diameter of the body 52 and vertical dimensions less than the vertical dimensions of the filter body 52. The basket 70 fits into the filter body 52, with the top edge of the filter member 70 being located below the open top of the filter body 52.

The filter member 70 has a plurality of perforated openings 72 formed about the circumference of the filter member to allow water to pass through the perforated basket into the body of the filter, while preventing debris from leaving the basket 70 with the flow of fluid. A handle 74 is secured to the top edge of the filter member 70 to facilitate removal of the basket 70 from the filter body 52 and emptying of the solid contaminants collected in the basket 70, as schematically shown in FIG. 3.

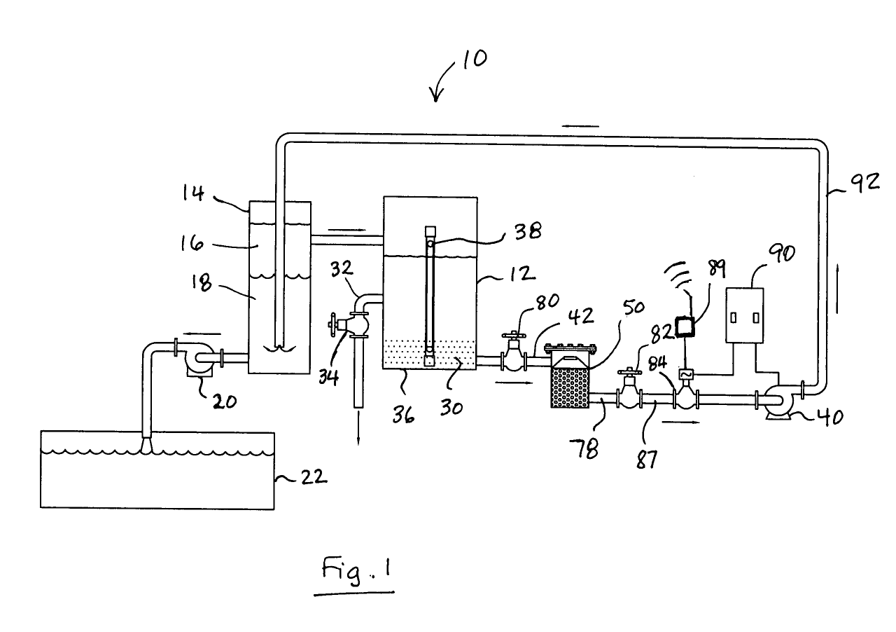

A filter inlet portion 76 of the conduit 42 is connected to the filter body 52 at a level above the top edge of the basket 70 (see, FIG. 1) to ensure that all intake water and suspended sediment is directed through the filter. A filter outlet is formed adjacent a bottom portion of the filter body 52. The filter outlet is connected to a filter outlet portion 78 of the conduit 42. A first filter shut-off valve 80 is mounted in the filter inlet portion 76, and a second filter shut-off valve 82 is mounted in the filter outlet portion 78. The valves 80, 82 are closed when the filter basket 70 is emptied of the collected debris.

A circulation pump control valve 84 is mounted upstream from the circulation pump 40 and downstream from the filter assembly 50 and the second filter shut-off valve 82. The control valve 84 is provided with a control unit 86, which detects an out-of-range pressure condition in the conduit portion 87 connecting the shut-off valve 82 with the control valve 84. The control unit 86 is provided with a pressure sensor and a transducer 89, which is activated by low level of liquid in the oil tank storage 12 or by a blockage in the filter assembly 50.

The control unit 86 is operationally connected to a power supply 90, which operates the pump 40. The transducer 89 of the control unit 86 shuts down power to the circulation pump 40 upon detection of the out-of-range condition. If desired, the transducer may be equipped with a wireless signal transmitter to inform a remote control station or an operator that the circulation pump has been de-activated.

By placing the control unit 86 at the intake of the pump 40 the system of the present invention protects the pump 40 from burning up because of no flow of fluid through the pump or too low pressure in the stock tank 12. The pressure switch of the control unit 86 is upstream of the pump 40, which allows it to sense the hydrostatic head in the oil stock tank 12.

The filter 50 catches debris that accumulates at the bottom of the oil storage tank 12 before any foreign matter is allowed to reach the recirculation pump 40. All solid materials that normally accumulate at the bottom of an oil tank in the field can be captured before they reach the impeller of the pump 40. Clogged pump impellers have a negative impact on total production. The system of the present invention alleviates the need for field maintenance that entails cleaning the impeller, which requires generally shutting down the entire collection process.

The catch basket 70 allows for easy cleaning and removal of the trash, thereby reducing the potential for pump downtime. The scrubber 50 also works to produce the low suction pressure when it is clogged such that a down stream pressure switch of the control unit 86 senses the low pressure and through a series of relay switches shuts down the pump 40, thereby protecting it from burning up because of no flow of fluid through the pump.

Normally, the removed filtered water is re-circulated through a conduit line 92, which connects the output of the pump 90 with the oil-water separator 14, from which it can be removed via a water pump 20 to a water reservoir 22. Alternatively, the conduit line 92 can be directly connected to the water reservoir 22. The pressure on the suction to the pump is created by the hydrostatic head of the oil in the stock tank 12, which may be blocked off because of the debris that accumulated in the basket 70.

Once the circulation pump receives the low pressure signal signaling that the basket in the scrubber is full of debris, an alarm signal generated by the transducer 89 of the control unit 86 is sent off to alert the operator to close the shut off valves 80, 82 on both sides of the scrubber 50. The operator then unbolts the lid 60 from the filter 50, removes the basket 70 from the filter body 52 and empties the trash out of the basket 70. The alarm signal may be a visual or audio signal, as well as a wireless signal sent to a remote location, computer, telephone and the like.

Once the basket 70 is clean, the operator places the basket back into the filter body 52, bolts the lid 60 back onto the filter body 52, opens the valves 80, 82 and manually overrides the pressure cutoff switch by the relays until such time as circulation is restarted. The circulation pump 40 continues re-circulation of the salt water until such time as sufficient debris is collected in the basket 70, which diminishes the pressure on the suction part of the circulation pump, as detected by the control unit 86.

The control unit 86 has a secondary protection feature, a 24-volt pressure micro switch with a reset button to ensure protection of the circulation pump 40. Should the flow of oil be reduced before reaching the pump, the micro switch will cut power to the pump until maintenance is initiated to restore flow to the system.

Many changes and modifications can be made in the design of the present invention without departing from the spirit thereof. I, therefore, pray that my rights to the present invention be limited only by the scope of the appended claims.

I claim:

1. A system for removing contaminants from a water stream in a circulation line, comprising:
a storage tank configured for retaining a pre-determined quantity of fluid containing unrefined oil, water and suspended solid contaminants;
a circulation conduit connected to the storage tank configured to remove water and suspended solids from the storage tank;
a circulation pump for moving the water stream through the circulation conduit;
a power source for operating the circulation pump;
a filter assembly mounted between the storage tank and the circulation pump for collecting suspended solids from the water stream; and
a control unit mounted in the circulation conduit between the filter assembly and the circulation pump, said control unit being configured to detect an out-of-range pressure in the circulation conduit before the water stream reaches the circulation pump.

2. The system of claim 1, wherein said control unit comprises a sensor for detecting low pressure in the circulation conduit and a transducer for sending a low-pressure signal to the power source and for de-activating the circulation pump upon receipt of the low-pressure signal.

3. The system of claim 2, wherein said transducer is configured to generate an alarm signal upon detection of out-of-range condition in the circulation conduit.

4. The system of claim 1, wherein said filter assembly comprises a hollow filter body having a closed bottom and an open top, a cover configured for normally covering the open top and a filter member mounted in the filter body.

5. The system of claim 4, wherein said filter member comprises a perforated basket having a top edge, said top edge extending below the open top of the filter body.

6. The system of claim 4, wherein said filter body is provided with a filter inlet connected to the circulation conduit, said filter inlet being oriented between the top edge of the filter member and the open top of the filter body.

7. The system of claim 4, wherein said filter member is provided with a handle secured adjacent the top edge.

8. The system of claim 4, wherein a plurality of openings is formed in the filter member, said opening being sized to allow water to pass through the filter member, while preventing solid contaminants to pass through the filter member.

9. The system of claim 1, further comprising a first shut-off valve mounted in the circulation conduit between the storage tank and the filter assembly, and a second shut-off valve mounted in the circulation conduit between the filter assembly and the control unit.

10. The system of claim 1, wherein said storage tank is provided with an oil outlet configured for removing unrefined oil separately from the water stream.

11. The system of claim 10, wherein said oil outlet is operationally connected to an oil removing conduit, said oil outlet being located above said circulation conduit.

12. A method of removing contaminants from a water circulation stream, comprising the steps:
providing a storage tank and depositing a pre-determined quantity of unrefined oil into the storage tank, said unrefined oil containing oil, water and suspended solids;
providing a circulation conduit connected to the storage tank;
providing a filter assembly and fluidly connecting the filter assembly to the circulation conduit;
collecting the suspended solids with the filter assembly, while allowing water to move through the filter assembly;
providing a circulation pump downstream from said filter assembly, said circulation pump being connected to a power supply;
providing a control unit and mounting the control unit between the circulation pump and the filter assembly;
detecting an out-of-range pressure condition in the circulation conduit;
transmitting a signal indicative of the out-of-range pressure condition to the power supply and de-activating the circulation pump; and
removing the suspended solids collected in the filter member.

13. The method of claim 12, wherein said control unit comprises a pressure sensor and a transducer.

14. The method of claim 13, wherein said step of transmitting a signal comprises a step of generating in the control unit an alarm signal and transmitting said alarm signal via the transducer.

15. The method of claim 13, wherein said transducer is operationally connected to the power supply.

16. The method of claim 13, wherein said transducer is configured to send an alarm signal to a remote location.

17. The method of claim 12, wherein said filter assembly comprises a hollow filter body having a closed bottom and an open top, a cover configured for normally covering the open top and a filter member mounted in the filter body.

18. The method of claim 17, wherein said filter member comprises a perforated basket having a top edge, said top edge extending below the open top of the filter body.

19. The method of claim 17, wherein said filter body is provided with a filter inlet connected to the circulation conduit, said filter inlet being oriented between the top edge of the filter member and the open top of the filter body.

20. The method of claim 17, wherein said filter member is provided with a handle secured adjacent the top edge, and wherein the step of removing the suspended solids comprises the step of removing the filter member for the filter body and emptying the filter member of collected suspended solids.
